(19) United States
(12) Patent Application Publication
(10) Pub. No.: US 2025/0293632 A1
(43) Pub. Date: Sep. 18, 2025

(54) ASSEMBLY FOR A MODULAR CHARGING SYSTEM

(71) Applicant: Ronald William Sledzieski, Charlotte, NC (US)

(72) Inventor: Ronald William Sledzieski, Charlotte, NC (US)

(21) Appl. No.: 18/603,688

(22) Filed: Mar. 13, 2024

(51) Int. Cl. H02S 20/30

(52) U.S. Cl. CPC H02S 20/30

(57) ABSTRACT

Disclosed is an assembly for a modular charging station, comprising a framework to accommodate a solar panel array. Further, the modular charging station comprises a lift assembly attached to the framework. The assembly operates between a deployed configuration, wherein the assembly is actuated upwards, and the solar panel array is operational, and a retracted configuration, wherein the assembly is retracted downwards, and the solar panel array is arranged in a reduced size.

### TECHNICAL FIELD

The present invention relates to a modular charging station. Specifically, the invention pertains to a framework to configure the modular charging system in various configurations.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

The accelerating adoption of Electric Vehicles (EVs) as a sustainable mode of transportation has underscored the imperative for a flexible and responsive charging infrastructure. While fixed EV charging stations have significantly contributed to the growth of the electric mobility ecosystem, there exists a persistent need for innovative solutions that address the limitations of conventional charging paradigms.

One key challenge is the immobility inherent in traditional charging infrastructure. Fixed stations necessitate EV users to plan routes meticulously, with charging stops pre-determined by the availability of established charging points. This constraint becomes particularly pronounced in scenarios where users deviate from anticipated routes or encounter unexpected situations such as depleted battery levels in remote locations, Mobile charging stations present a viable solution to this challenge by offering flexibility in addressing temporary needs. This adaptability is particularly crucial in situations like post-natural disasters when the grid power is compromised. Furthermore, mobile charging stations prove invaluable in catering to temporary requirements, such as events and festivals, where the demand for charging exists but access to grid power is not readily available. However, these aspects are not properly implemented yet.

Therefore, there is an utmost need for a portable, yet modular EV charging assembly, and thus formed genesis for this invention.

### SUMMARY

Before the present system and its components are described, it is to be understood that this disclosure is not limited to the particular system and its arrangement as described, as there can be multiple possible embodiments which are not expressly illustrated in the present disclosure. It is also to be understood that the terminology used in the description is for the purpose of describing the particular versions or embodiments only and is not intended to limit the scope of the present application. This summary is not intended to identify essential features of the claimed subject matter nor is it intended for use in detecting or limiting the scope of the claimed subject matter.

The present disclosure relates to an assembly, comprising a framework to accommodate a solar panel array, a guide rail parallel and offset to the platform by a predefined height, and a lift assembly attached to the framework. Further, the assembly may be operated between a deployed configuration and a retracted configuration. In the deployed configuration, the assembly may be actuated upwards, and the solar panel array may be operational. Further, in the retracted configuration, the assembly may be retracted downwards, and the solar panel array is arranged in a reduced size.

### BRIEF DESCRIPTION OF FIGURES

The detailed description is described with reference to the accompanying Figures. In the Figures, the left-most digit(s) of a reference number identifies the Figure in which the reference number first appears. The same numbers are used throughout the drawings to refer like features and components.

FIG. 1 illustrates a perspective view of a solar panel array assembled with a framework in a deployed configuration, as an illustrative embodiment of the present disclosure.

FIG. 2 illustrates a left-side view of the solar panel array assembled with the framework in the deployed configuration, as an illustrative embodiment of the present disclosure.

FIG. 3 illustrates a right-side view of the solar panel array assembled with the framework in the deployed configuration, as an illustrative embodiment of the present disclosure.

FIG. 4 illustrates a front view of the solar panel array assembled with the framework in the deployed configuration, as an illustrative embodiment of the present disclosure.

FIG. 5 illustrates a top view of the solar panel array assembled with the framework in the deployed configuration, as an illustrative embodiment of the present disclosure.

FIG. 6 illustrates a perspective view of the solar panel array assembled with the framework in the retracted configuration, as an illustrative embodiment of the present disclosure.

FIG. 7 illustrates a front view of the solar panel array assembled with the framework in the retracted configuration, as an illustrative embodiment of the present disclosure.

FIG. 8 illustrates a right-side view of the solar panel array assembled with the framework in the retracted configuration, as an illustrative embodiment of the present disclosure.

### DETAILED DESCRIPTION

Before the present apparatus and its components are described, it is to be understood that this disclosure is not limited to the particular apparatus and its arrangement as described, as there can be multiple possible embodiments which are not expressly illustrated in the present disclosure. It is also to be understood that the terminology used in the description is for the purpose of describing the particular versions or embodiments only and is not intended to limit the scope of the present application. This summary is not intended to identify essential features of the claimed subject matter nor is it intended for use in detecting or limiting the scope of the claimed subject matter.

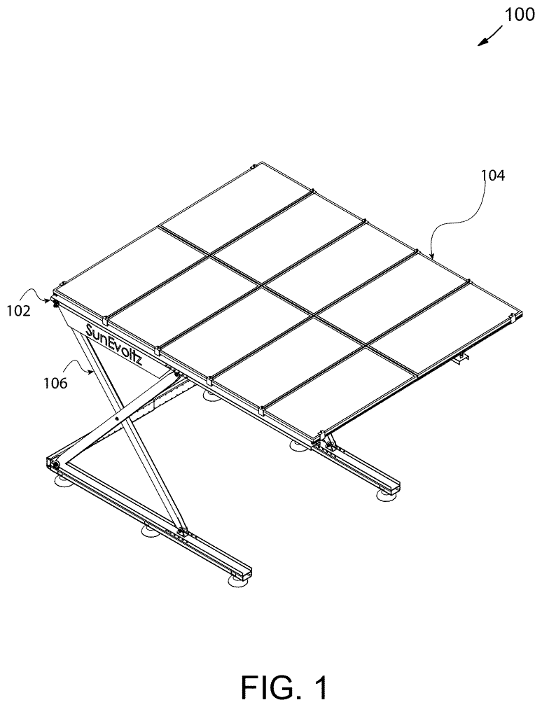

Addressing the needs for the portable yet modular EV charging stations, the present disclosure discloses an assembly related to a Modular EV charging station formed by a coupling of a solar panel array with a framework, which is further rested on a lifting assembly. The assembly may be actuated between a deployed configuration and a retracted configuration, which is explained in detail in conjunction with FIGS. 1-8.

In one embodiment, now referring to FIG. 1, which illustrates a perspective view 100 a solar panel array assembled with a framework in a deployed configuration, as an illustrative embodiment of the present disclosure. As explained earlier, the assembly may comprise a Modular EV charging station formed by accommodating a solar panel array 104 on a framework 102. Further, the framework 104 may be further rested on a lifting assembly 106.

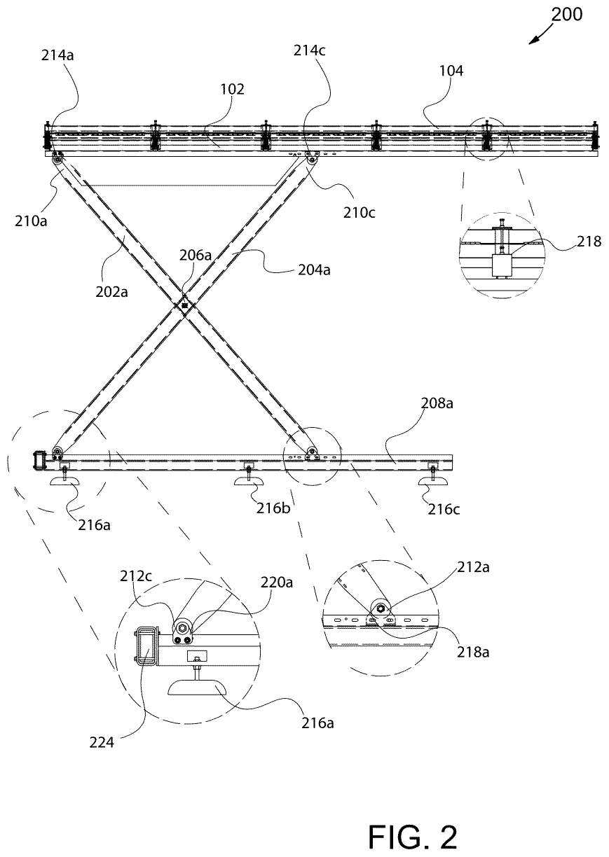

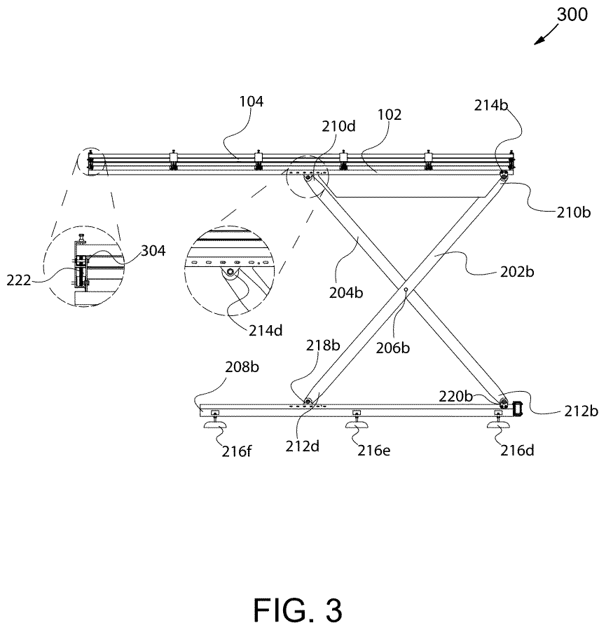

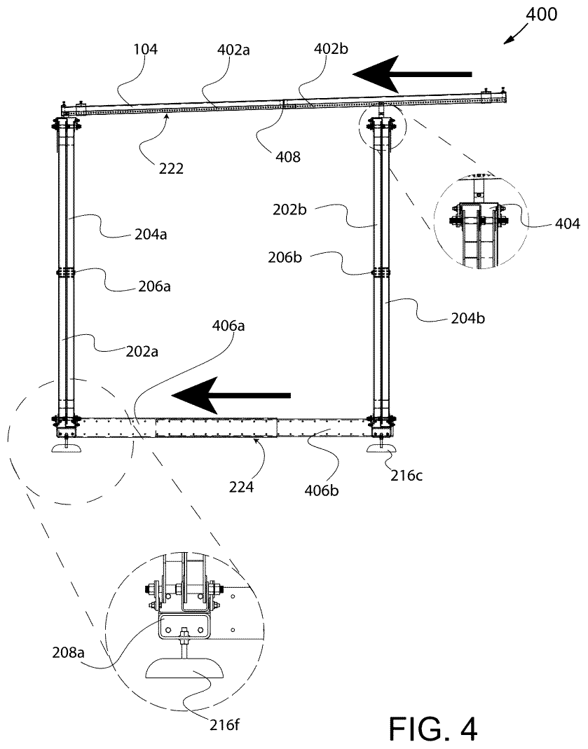

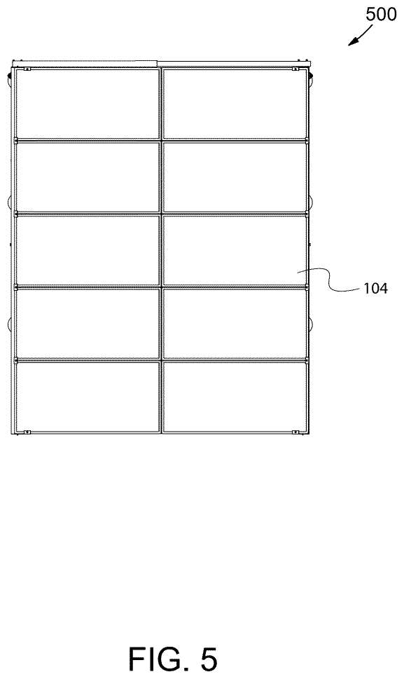

Now, FIG. 2 illustrates a left-side view 200 of the solar panel array 104 assembled with the framework 102 in the deployed configuration, FIG. 3 illustrates a right-side view 300 of the solar panel array assembled with the framework 102 in the deployed configuration, as an illustrative embodiment of the present disclosure, FIG. 4 illustrates a front view 400 of the solar panel array 104 assembled with the framework 106 in the deployed configuration, as an illustrative embodiment of the present disclosure, and FIG. 5 illustrates top view 500 of the solar panel array 102 assembled with the framework in the deployed configuration. as an illustrative embodiment of the present disclosure.

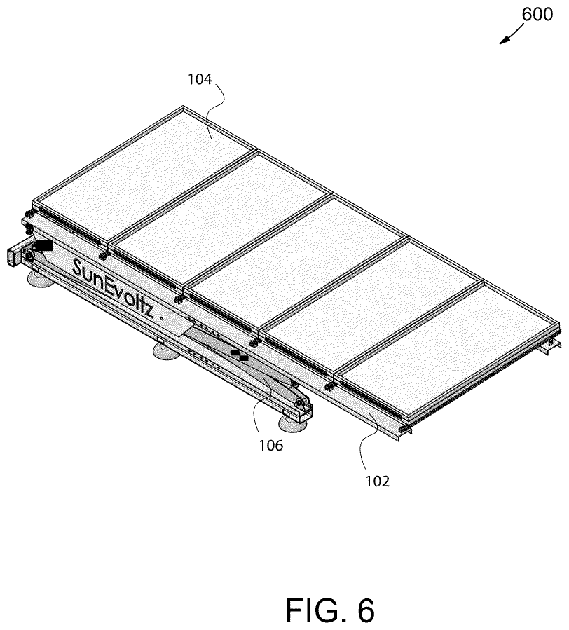

The solar panel array 106, as explained earlier, is mounted on the framework 102, which is further mounted on the lifting assembly 106. The lifting assembly 106 comprises, but not limited to a scissor-lift assembly. The lifting assembly 106 may be actuated to alter the modular EV charging station between the deployed configuration, and a retracted configuration (refer to FIGS. 6-8).

In one embodiment, the lifting assembly 106 may comprises a pair of scissor frames parallel to and offset from each other by a predefined distance and slidingly positioned on a pair of base bars 208a, 208b. For example, referring to FIG. 2, the pair of scissor frames may comprises a first arm 202a, a second arm 202b, a third arm 204a, and a fourth arm 204b. A scissor frame may be formed by the first arm 202a and a third arm 204a pivoted at a first pivot 206a. Similarly, referring to FIG. 3, another pair of scissor frames may be formed by a third arm second arm 202b and a fourth arm 204b pivoted about a second pivot point 206b. The pair of scissor frames are positioned parallel to each other in such a manner that a common imaginary axis (not shown in figure) coincides the first pivot point 206a and the second pivot point 206b. Accordingly, the pair of scissor frames may be actuated in unison, i.e., under same motion such that the deployed configuration, and the retracted configuration may be seamlessly obtained.

In one embodiment, each of the first arm 202a, the second arm 202b, the third arm 204a, and the fourth arm 204b may comprises upper ends 210a. 210b, 210c, and 210d, respectively. Accordingly, in a similar fashion, the second arm 202b, the third arm 204a, and the fourth arm 204b may comprises lower ends 212b, 212c, and 212d, respectively. The upper ends 210a, 210b, 210c, and 210d may be rotatably pivoted to the framework 102, and at least one of the lower ends 212a, 212b, 212c, and 212d of each of the pair of scissor frames may be slidingly engaged on base bars 208a, 208b.

In one embodiment, each of the upper ends 210a, 210b, 210c, and 210d may be rotatably pivoted with respective pivot points about the framework 102. For e.g., upper end 210a may be pivoted to the framework 102 about a pivot point 214a. Similarly, upper ends 210b, 210c, and 210d may be pivoted about pivot points 214b, 214c, and 214d, respectively. The pivot points 214a, 214b, 214c, and 214d may enable the first arm 202a, the second arm 202b, the third arm 204a, and the fourth arm 204b to freely rotate about the framework 106.

In one embodiment, each of the lower ends 212a, 212b, 212c, and 212d of the first arm 202a, the second arm 202b, the third arm 204a, and the fourth arm 204b may be slidingly engaged, or pivoted, or pivoted and slidingly engaged to the base bars 208a, 208b. For e.g., the lower end 212b may be slidingly pivoted to the base bar 208a about a sliding pivot 218a, and the lower end 212c may be fixated to the base bar 208a using a fixed pivot 220a. Accordingly, the lower end 212d may be fixated to the base bar 208b using a sliding pivot 218b, and the lower end 212b may be fixated to the base bar 208b using the fixed pivot 220b. The sliding of the sliding pivots 218a, 218b along the base bars 208a, 208b may be configured to transition the assembly from the deployed condition to the retracted condition and vice versa.

In one embodiment, the base bars 208a, 208b are supported on one or more supports 216a-216d. the one or more supports 216a-216d may be configured to provide stability to the solar panel array 104 assembled with the framework 102 in the deployed configuration. In one embodiment, the solar panel array after being positioned on the framework 102, may be clamped thereto using a clamp 302. Alternatively, the base bars 208a, 208b may be equipped with a set of wheels instead/or with the one or more supports 216a-216d, such that easily mobility can be achieved during the retracted configuration, or the deployed configuration. In an embodiment, for ease in installation, the framework 104 may be equipped with pulleys, or similar means such that the complete assembly may be lifted easily using any lifter machines known in the art.

Furthermore, the extremities of the base bars 208a, 208b may be adjoined using a telescopic beam 222. Also, the framework 102 may also comprises another telescopic beam 224 or a set of retractable bars comprising one or more telescopic beam 224. This is explained in detail in FIG. 4.

Now, referring to FIG. 4, the first telescopic beam 222 may be formed by an assembly of a first beam 402a and a second beam 402b. As the name suggests, telescopic beam may signify one or more beams configured to mechanically slide, i.e., the first beam 402b may be allowed to slide in-and-out from the second beam 402b. In one embodiment, the one or more retractable bars may comprises one or more second telescopic beam 224, each of which may also include a first base beam 406a and a second base beam 406b. In one embodiment, the second base beam 406b may be allowed to slide in-and-out from the first base beam 406a.

In one embodiment, in the deployed configuration, the second beam 402b may be completely extended from the first beam 402a, and the second base beam 406b may be completely extended from the first base beam 406a. Accordingly, complete extension of the second beam 402b from the first beam 402a may be configured to provide maximum effective area to accommodate the solar panel array 104, while complete extension of the second base beam 406b from the first beam 406a may form a predefined space between the pair of scissor frames. Therefore, when implemented as a power charging station, this predefined space may be configured to accommodate Electric vehicles, or any utilities that require electric-based power recharge.

In one embodiment, the solar panel array 104 may comprises at least one solar panel connected using a hinge connection 408. For e.g., a first solar panel may be connected to the second solar panel using a hinge connection. Accordingly, in the deployed configuration, the first solar panel may be rotated about the second solar panel through the hinge connection 408 such that a planar configuration of the solar panel array 104 may be obtained which may be accommodated on the framework 102 in the deployed configuration, which is illustrated by FIG. 5. In one embodiment, to obtain maximum electrical output from the solar panel array 104, the solar panel array may be positioned at a predefined angle with respect to the framework 102. Therefore, at least one end of the solar pane array 104 may be equipped with a height adjustment plate 404. The height adjustment plate 404 may be configured to elevate the solar panel array 104 from the end at which it is equipped, such that the solar panel array 104 may be elevated to a desired inclination in the deployed configuration.

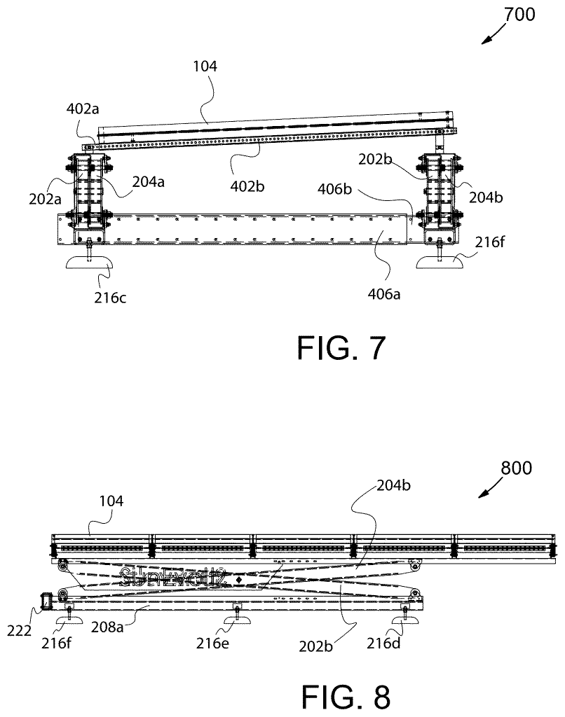

Now, referring to FIG. 6 which illustrates a perspective view 600 of the solar panel array 104 assembled with the framework 102 in the retracted configuration, as an illustrative embodiment of the present disclosure, FIG. 7 illustrates a front view 700 of the solar panel array 104 assembled with the framework 102 in the retracted configuration, as an illustrative embodiment of the present disclosure, and FIG. 8 which illustrates a right-side view 800 of the solar panel array 800 assembled with the framework 102 in the retracted configuration, as an illustrative embodiment of the present disclosure.

In one embodiment, to transition the assembly from the deployed configuration to the retracted configuration, the solar panel array 104 may be rotated about the hinge connection 408 (refer to FIG. 4) to achieve a stacked configuration, i.e., the second solar panel may be rotated about the hinge connection 406 and stacked onto the first solar panel. Further, the second beam 402b may slide within the first beam 402a, and the second base beam 402b may slide into the first base beam 402a. Accordingly, the pair of scissor frames may slide on the base bars 208a, 208b and retracted downwards, and hence, the complete assembly may be retracted and hence, may be deemed fit for transportation to areas having less access to grid communication. While installation, the above process may be reversely operated to lift the lifting assembly in an upwards direction to achieve the deployed configuration.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated but is to be accorded the widest scope consistent with the principles and features described herein.

The foregoing description shall be interpreted as illustrative and not in any limiting sense. A person of ordinary skill in the art would understand that certain modifications could come within the scope of this disclosure.

The embodiments, examples and alternatives of the preceding paragraphs or the description and drawings, including any of their various aspects or respective individual features, may be taken independently or in any combination. Features described in connection with one embodiment are applicable to all embodiments unless such features are incompatible.

1. An assembly for a modular charging station, comprising:
a framework to accommodate a solar panel array; and
a lift assembly attached to the framework;
wherein the assembly operates between:
a deployed configuration, wherein the assembly is actuated upwards, and the solar panel array is operational; and
a retracted configuration, wherein the assembly is retracted downwards, and the solar panel array is arranged in a reduced size.

2. The assembly as claimed in claim 1, wherein the framework comprises:
a first arm;
a second arm;
a third arm;
a fourth arm, wherein:
the first arm is pivoted to the third arm about a first pivot; and
the second arm is pivoted to the fourth arm about a second pivot.

3. The assembly as claimed in claim 2, wherein the first arm, the second arm, the third arm, and the fourth arm respectively comprises first ends coupled to the framework, and second ends coupled to base bars.

4. The assembly as claimed in claim 1, wherein the framework is supported on a set of retractable bars, each retractable bar comprising:
a first bar; and
a second bar slidingly arranged within the first bar, wherein:
the second bar is accommodated within the first bar in the retracted configuration; and
the second bar extends from the first bar up to a predefined length to support the platform in the deployed configuration.

5. The assembly as claimed in claim 1, wherein the framework comprises:
at least one set of wheels installed on the base bars.

6. The assembly as claimed in claim 1, wherein the framework comprises:
at least one set of pulleys formed on at least one of:
the first arm;
the second arm;
the third arm; and
the fourth arm.

7. The assembly as claimed in claim 1, wherein the solar panel array comprises:
a first solar panel; and
a second solar panel attached to the first solar panel via a hinge connection,
wherein the first solar panel and the second solar panel are arranged in a planar configuration and a stacked configuration.

8. The assembly as claimed in claim 1, wherein the planar configuration comprises:
the first solar panel and the second solar panel arranged on the same plane.

9. The assembly as claimed in claim 1, wherein the stacked configuration comprises:
the first solar panel rotated about the hinge connection and stacked on the second solar panel.

10. The assembly as claimed in claim 1, wherein the framework comprises:
at least one support adjoined to the base bars.

11. A modular charging station, comprising:
an assembly, comprising:
a framework to accommodate a solar panel array; and
a lift assembly attached to the framework;
wherein the assembly operates between:
a deployed configuration, wherein the assembly is actuated upwards, and the solar panel array is operational; and
a retracted configuration, wherein the assembly is retracted downwards, and the solar panel array is arranged in a reduced size.

12. The modular charging station as claimed in claim 11, wherein the framework comprises:
a first arm;
a second arm;
a third arm;
a fourth arm, wherein:
the first arm is pivoted to the third arm about a first pivot; and
the second arm is pivoted to the fourth arm about a second pivot.

13. The modular charging station as claimed in claim 12, wherein the first arm, the second arm, the third arm, and the fourth arm respectively comprise first ends coupled to the framework, and second ends coupled to base bars,

14. The modular charging station as claimed in claim 11, wherein the framework is supported on a set of retractable bars, each retractable bar comprising:
a first bar; and
a second bar slidingly arranged within the first bar, wherein:
the second bar is accommodated within the first bar in the retracted configuration; and
the second bar extends from the first bar up to a predefined length to support the platform in the deployed configuration.

15. The modular charging station as claimed in claim 11, wherein the framework comprises:
at least one set of wheels installed on the base bars.

16. The modular charging station as claimed in claim 11, wherein the framework comprises:
at least one set of pulleys formed on at least one of:
the first arm;
the second arm;
the third arm; and
the fourth arm.

17. The modular charging station as claimed in claim 11, wherein the solar panel array comprises:
a first solar panel; and
a second solar panel attached to the first solar panel via a hinge connection,
wherein the first solar panel and the second solar panel are arranged in a planar configuration and a stacked configuration.

18. The modular charging station as claimed in claim 11, wherein the planar configuration comprises:
the first solar panel and the second solar panel arranged on the same plane.

19. The modular charging station as claimed in claim 11, wherein the stacked configuration comprises:
the first solar panel rotated about the hinge connection and stacked on the second solar panel.

20. The modular charging station as claimed in claim 11, wherein the framework comprises:
at least one support adjoined to the base bars.
